(19) United States
(12) Patent Application Publication
(10) Pub. No.: US 2024/0046370 A1
(43) Pub. Date: Feb. 8, 2024

(54) Supplemental Tax Protocol System and Method

(71) Applicant: SafeMoon US, LLC, Pleasant Grove, UT (US)

(72) Inventor: Adel ElMessiry, Brentwood, TN (US)

(21) Appl. No.: 18/229,904

(22) Filed: Aug. 3, 2023

Related U.S. Application Data
(60) Provisional application No. 63/394,990, filed on Aug. 4, 2022.

(51) Int. Cl. G06Q 40/10; G06Q 20/38; G06Q 20/06

(52) U.S. Cl. CPC G06Q 40/10; G06Q 20/389; G06Q 20/0658

(57) ABSTRACT

A system and method for calculating supplemental taxes associated with a cryptocurrency transaction and automatically deducting such supplemental taxes upon execution of a transaction.

### CROSS REFERENCE TO RELATED APPLICATIONS

This application claims priority to U.S. provisional patent application 63/394,990, filed on Aug. 4, 2022.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

Cryptocurrency is a digital asset class comprised of fungible cryptographic tokens which can be used to purchase goods and services, and which are also treated by the investing public as securities. Crypto transactions occur on decentralized exchanges, meaning that the exchanges occur without the involvement of banks, financial institutions or governmental authorities. Some virtual currencies are convertible, which means that they have an equivalent value in real currency or act as a substitute for real currency.

Blockchain projects may impose a tax on the project token. This tax is typically charged in three cases, namely: transfer, buy or sell. Blockchain projects often implement a tax mechanism on their native project token as a way to achieve various objectives, such as promoting token utility, incentivizing long-term holding, funding project development, and discouraging short-term speculative trading. This tax, commonly referred to as a “transaction tax” or “token tax,” is charged to token holders under three specific scenarios: transfer, buy, or sell, as follows:

1. Transfer Tax: When a token holder transfers their tokens from one wallet to another, a transfer tax may be applied. This tax serves multiple purposes. For instance, it can act as a deterrent against excessive token movements, reducing the likelihood of rapid and frequent transfers that could create price volatility. Additionally, the transfer tax can generate revenue for the project related to the token, which can be utilized for various initiatives, such as marketing, community development, or funding future protocol upgrades.

2. Buy Tax: When a user purchases tokens from the project or from other holders, a buy tax may be levied. The primary objective of the buy tax is to encourage long-term holding and discourage speculative buying for short-term gains. By imposing a tax on token purchases, the project aims to incentivize investors to hold onto their tokens for more extended periods, contributing to a more stable token price and fostering a committed and engaged community.

3. Sell Tax: Similarly, when a token holder sells their tokens, a sell tax may be applied. The sell tax is designed to discourage frequent and large-scale token dumping, which can lead to significant price fluctuations and negatively impact the token's value. By implementing a sell tax, the project encourages holders to carefully consider their selling decisions and, ideally, hold their tokens for more extended periods, aligning their interests with the long-term success of the project.

It's important to note that the specific tax rates and mechanisms can vary widely among different blockchain projects. Some projects may have a fixed tax rate, while others may implement dynamic tax structures that adjust based on factors like transaction size or token price. Additionally, the revenue generated from these taxes may be allocated differently, depending on the project's governance and tokenomics.

The disclosure relates to a protocol or system for deducting supplemental taxes, specific to certain taxing authorities and owed to government entities from token transactions effected through decentralized exchanges and related method of use.

### Background of the Invention

Various world taxing authorities have differing rules related to the levying of taxes on digital asset purchase and exchange transactions. Similarly, fees are charged according to smart contracts associated with specific cryptocurrency tokens for the purpose of encouraging stability and maximizing valuation in such tokens. These token-related fees are also referred to as “taxes”.

At present, these taxes must be calculated, reported and levied on transaction participants following an exchange. As a result, the tax amounts owed are often unknown until after the transaction has occurred.

The present invention is directed generally to decentralized exchanges (DEX), in particular, those handling crypto tokens swapping where the token requires asymmetric tax, or fees, to complete the buy or sell transactions. The inventive system both allows for transaction participants to know the relevant tax amounts before executing the transaction and for the deduction of the levied taxes simultaneously with such execution and subsequent payment to the relevant authority by the DEX.

### BRIEF DESCRIPTION OF THE INVENTION

In a preferred embodiment, a system for calculating and deducting supplemental taxes in cryptocurrency transactions, such system comprising the following components:
one or more user devices, each such user device comprising a processor, an input feature, a memory containing a decentralized exchange application (dApp), such dApp comprising a crypto wallet;
a plurality of servers comprising a blockchain, each such server with a processor and a memory containing a decentralized exchange protocol (collectively, a DEX), such protocol comprising a liquidity pool (LP) containing tokens, one or more DEX smart contracts and one or more LP smart contracts;
a supplemental tax protocol (STP) with an STP register, each residing on each server memory and engaged by the DEX; and
an internet, intranet or similar means of communication between such system components;
   wherein the system executes the following steps:
1. initiating a proposed cryptocurrency transaction, such transaction a transfer, buy or sell transaction, by the user on the user device;
2. determining a valuation of the tokens to be sold, purchased or transferred with the DEX smart contract;
3. determining a default tax amount to be levied against those tokens to be sold or transferred by the user with the DEX smart contract;
4. if the transaction is a transfer, reviewing the LP smart contract contents with the DEX smart contract to determine if the tokens requested for transfer are in the LP;
5. if the transaction is a transfer and the LP contains the tokens to be transferred, determining the correct transfer fee to be charged with the DEX smart contract;
6. if the transaction is a sale or purchase, communicating the correct default tax amount from the DEX smart contract to the dApp on the user device, wherein the dApp then prompts the user to execute or cancel the order;
7. if the transaction is a transfer, determining whether the tax is flat, symmetric or asymmetric with the DEX smart contract;
8. if an asymmetric tax is applicable to a transfer transaction, engaging the STP with the DEX smart contract;
9. registering the token with the STP and verifying that the token appears on the STP register;
10. once the STP is engaged, computing the supplemental tax applicable to the transaction with the DEX smart contract and communicating the combined default and supplemental tax amount to the dApp on the user device, prompting the user to execute or cancel the order;
11. if the user executes the order through the dApp, executing the transaction with the DEX smart contract, thereby automatically deducting all applicable default and supplemental taxes and transferring tokens as computed into and/or out of the LP and the user's crypto wallet; and
12. upon execution of the transaction, transferring the withheld tax from the DEX smart contract to the designated entity's wallet.

In another preferred embodiment, the system as described herein, wherein step 10 reads as follows: automatically parsing a contract code of the token with the STP and determining whether a supplemental tax is associated with the token and, if so, calculating the supplemental tax amount.

In another preferred embodiment, a of deducting a supplemental tax on a token transaction with the system as described herein, comprising the steps:
registering a token with the STP;
calculating an actual tax to be deducted in relation to a transfer, buy or sell transaction;
calculating the required supplemental tax in the transaction
initiating the transaction on the DEX smart contract;
verifying that the token appears on the STP register; and
charging a supplemental tax in addition to the actual tax deducted upon execution of the transaction.

### BRIEF DESCRIPTION OF THE DRAWINGS

FIG. 1 is a flow chart showing potential token classification based on the transaction tax.

FIG. 2 is a flow chart showing an embodiment of the inventive system.

FIG. 3 is a flow chart showing an alternate embodiment of the inventive system.

FIG. 4 is a flow chart showing another embodiment of the inventive system using auto-detection.

FIG. 5 is a chart showing the hardware components required for the inventive system.

### DETAILED DESCRIPTION OF THE INVENTION

### Definitions

Decentralized Exchange (DEX): Decentralized Exchanges (DEXs) are transformative platforms that leverage blockchain technology to offer users a trustless and non-custodial way to trade cryptocurrencies. Unlike centralized exchanges, DEXs empower users by providing full control over their funds and ensuring enhanced security through smart contracts. These self-executing contracts automate trade execution, while liquidity pools ensure sufficient trading volume. User privacy is respected, and interoperability with various blockchain networks enables seamless cross-chain trading. While DEXs face regulatory considerations and technical challenges, their open-source nature fosters transparency and innovation, driving the evolution of decentralized finance (DeFi). With ongoing developments like layer-2 solutions, DEXs hold the promise of creating a more inclusive, decentralized, and resilient financial ecosystem for the future.

Liquidity Pool (LP): smart contracts containing locked tokens that have been supplied by a given DEX's users. LPs are self-executing and do not need intermediaries for functionality.

Smart Contract: computer programs or protocols for automated transactions that are stored on a blockchain and run in response to meeting certain preset conditions, removing the need for the parties to the transaction to establish mutual trust. Smart contracts are self-executing computer programs that operate on a blockchain, designed to automate and enforce the terms of agreements without the need for intermediaries. These contracts use the decentralized nature of blockchain technology to ensure transparency, security, and immutability. Once deployed, smart contracts automatically execute actions based on predefined conditions being met, eliminating the risk of human error and bias. They facilitate various applications, ranging from financial transactions and supply chain management to voting systems and decentralized applications (dApps). Smart contracts revolutionize traditional contract processes by providing a more efficient, trustless, and decentralized way of executing agreements in the digital era.

Token: a digital unit designed as an asset for purchase and sale, providing access and use of a crypto economic system.

The inventive supplemental tax protocol (STP) is a computer protocol comprising a database of tokens and associated supplemental taxes, with the STP residing on the memories of the plurality of servers dedicated to a DEX and engaged by the DEX smart contract. Each such server will also incorporate a server processor for implementing protocol rules, including those governing the exchange or transmission of data between the server(s) and other devices, which will include a plurality of user devices, each with its own user device memory and processor, whereby users will interact with the DEX servers and STP when trading cryptocurrencies or other digital assets. For cryptocurrency transactions, user device memories will contain the users' crypto wallets, which are software applications that access a blockchain network for a given type of token. The servers and user devices will be connected and able to transmit data through an internet, intranet or similar means of data transmission.

In a standard DEX token transaction, the DEX protocol for each type of transaction, transfer, buy or sell, are designated certain taxes depending on the size of the transaction and the jurisdiction(s) in which the users reside and/or the jurisdiction(s) from which the users are conducting their transaction. These taxes may either be flat or variable in nature, depending on token values designated by the DEX. If variable, the taxes may either be symmetric, meaning charged to both user parties equally, or asymmetric, with one party being taxed more heavily than the other. As the transaction takes place, these taxes are deducted by the DEX protocol such that the amount of token received by each party to the transaction is adjusted downward to account for the tax amount, and the DEX protocol further designates such amounts for payment to the appropriate taxing jurisdictions. Those taxes are hardcoded in the protocol to limit the protocol to the initial values that were set when the protocol was deployed.

Furthermore, token smart contracts may have tax values imposed on the token transfer. When the token smart contract is deployed, normally, the contract would include an exception list called a “White List” that exempts some transfers based on either the sending or receiving address. Those lists may not be updatable and thus pose a challenge for the token operation itself limiting the potential of the project.

To overcome the above limitations, a new contract must be deployed on most blockchains. this will lead to the creation of a new address and thus invalidate the current one. In some extreme cases, it could result in a chain forking. In situations where an error or vulnerability is discovered within the blockchain's protocol, software, or smart contracts, the community may decide to implement a fork to rectify the issue. Forking involves creating a duplicate version of the existing blockchain, branching off from a specific block. One branch continues with the original rules and data (often referred to as the “main” or “legacy” chain), while the other branch adopts the corrected rules and data (known as the “forked” or “updated” chain). This process allows the community to reach a consensus on the necessary fix and maintain network integrity. While hard forks can result in a temporary split and require significant coordination, they are essential for maintaining the trust, security, and immutability of the blockchain ecosystem, ensuring that errors are swiftly addressed to safeguard the interests of users and stakeholders.

In a first exemplary embodiment of the STP, a token is registered with the STP by logging the token and related supplemental tax information into the STP, thus making available the required supplemental tax in one or all of the transaction cases such as: transfer, buy, or sell. When a transaction is initiated on the DEX, the server processor will activate the STP to verify whether the token is registered in the STP. If the token is registered, the protocol will instruct the DEX processor to charge the appropriate supplemental tax to the user in addition to other taxes automatically applied, thereby correcting the actual tax deducted.

In another exemplary embodiment, the token is registered in the STP with a reference to a hardcoded DEX, wherein DEX parameters are programed such that they cannot be revised without modifying the underlying algorithm. A hardcoded parameters DEX (Decentralized Exchange) refers to a type of decentralized exchange that operates with fixed and predetermined settings or rules within its smart contract code. Unlike some other decentralized exchanges that allow for flexibility and governance through user voting or adjustable parameters, hardcoded parameters DEXs lack the ability to modify critical elements without making changes to the underlying smart contract code and redeploying it. While this approach can provide simplicity and security by eliminating potential vulnerabilities introduced through parameter adjustments, it may also limit the DEX's adaptability to changing market conditions or user preferences. The effectiveness of a hardcoded parameters DEX largely depends on the initial choices made during its development, which could both be advantageous and restrictive in different scenarios.

The hardcoded DEX correctly deducts the tax. In this embodiment, the STP would automatically calculate the supplemental tax based on the reference DEX. When a transaction is initiated on the DEX, the server processor checks whether the token is registered in the STP. If the token is registered, a supplemental tax is charged to the user to correct the actual tax deducted.

In another exemplary embodiment, the STP would automatically detect the encoded tax by methods such as: parsing the token contract code. In this embodiment, the STP compares the actual tax deducted in the transaction against the one detected from one of the methods above. When a transaction is initiated on the DEX, the system will automatically determine if the token qualifies for the STP without requiring registration of the token. The STP automatically determines the missing token tax by contrasting the transaction tax with the expected tax obtained from automatically analyzing the token smart contract. When a transaction involving a token occurs on the blockchain, the STP first checks if any transaction tax is applied at the time of execution. This may include fees or taxes imposed on the token transfer, which could be coded directly into the transaction.

Next, the STP proceeds to automatically analyze the smart contract associated with the token. By parsing the smart contract code, the protocol extracts relevant information about any tax-related rules or parameters encoded within the contract. These rules could include tax rates, conditions triggering taxes, or any other tax-related instructions.

After obtaining both the transaction tax and the expected tax from the smart contract analysis, the STP compares the two values. If the transaction tax matches the expected tax based on the contract analysis, then no further action is needed, as the tax is correctly applied.

However, if there is a discrepancy between the transaction tax and the expected tax from the contract analysis, the STP identifies that there is a missing token tax or a potential error in the tax implementation. In such cases, the STP can automatically charge the supplemental tax amount to rectify the situation.

It should be noted that, in each of the above embodiments, full tax information, including the application of supplemental taxes, if any, is communicated from the STP to the user device via the DEX server prior to user's decision to complete the transaction. Thus, the user is given complete transparency as to the fees and charges related to the purchase, sale or transfer of the user's new token before the transaction is completed and may decide to abort the transaction if the fees and charges are deemed too high.

### DETAILED DRAWING DESCRIPTION

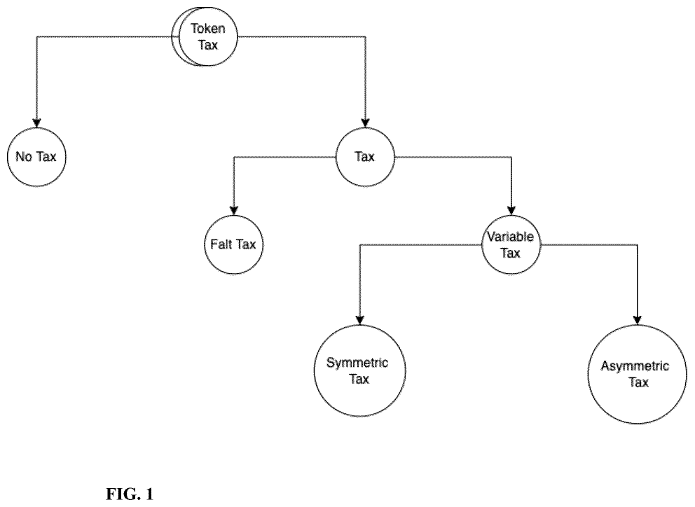

As depicted in FIG. 1, a typical transaction first can be classified based upon whether tax is associated with the transaction or not. For those tokens requiring payment of a transaction tax, such tokens can be classified as either flat tax tokens or variable tax tokens. A flat tax token will involve the same amount of tax on every transaction, regardless of the number or type of transactions executed over time. In contrast, the amount of tax payable on a variable tax token per transaction will be subject to adjustment based on factors such as the value, frequency or type of the transaction.

Variable tax tokens can be subclassified into symmetrical and asymmetric tax tokens, based on whether or not the two parties to an exchange are taxed the same or not. Transactions involving symmetrical tax tokens will carry the same tax for buy and sell transactions. Asymmetric tax tokens will carry a different tax based on whether the transaction being executed is a purchase or a sale.

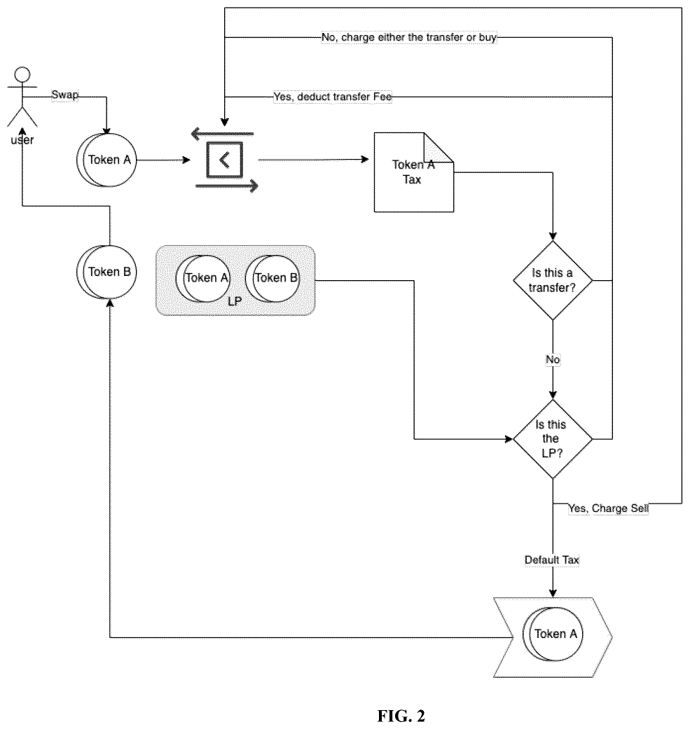

As depicted in FIG. 2, token transaction can include different modalities. The basic transaction is a simple transfer transaction, which occurs between at least two crypto wallets, each on a separate user device, and involves sending a single token or more from the first wallet to the second wallet.

Another type of transaction is the swap transaction. A typical token swap transaction occurs through a liquidity pool (LP), located on the DEX server memory, in which one token is swapped for another. In a typical swap, a smart contract would attempt to deduce the type of transaction by validating the swapped token pair address. A blockchain liquidity pool is a mechanism used in decentralized exchanges (DEXs) to facilitate trading between two different tokens, let's say Token A and Token B. Liquidity pools are an essential part of decentralized finance (DeFi) and are typically implemented on automated market maker (AMM) protocols.

1. Initial Pool Creation: To set up a liquidity pool, an equal value of Token A and Token B needs to be deposited into the pool. For instance, if you deposit 1 Token A, you also need to deposit an equivalent value of Token B. This ensures an initial balance and establishes the pool's liquidity.

2. Pricing Algorithm: Liquidity pools use a pricing algorithm to determine the exchange rate between Token A and Token B. The most commonly used algorithm is the constant product market maker formula (x*y=k). In this formula, ‘x’ and ‘y’ represent the quantities of Token A and Token B in the pool, and ‘k’ is a constant value. As trades occur, the algorithm maintains the product of Token A and Token B balances.

3. Swapping Tokens: Traders can swap Token A for Token B or vice versa directly from the liquidity pool. When a user wants to make a trade, the smart contract automatically calculates the resulting amount based on the current liquidity pool's reserve ratio.

4. Fees and Incentives: Liquidity providers who deposit their tokens into the pool earn rewards in the form of trading fees. Each time a trade occurs, a small percentage of the trade (usually around 0.3%) is charged as a fee, which is distributed among liquidity providers in proportion to their share of the pool.

Liquidity pools provide a decentralized and efficient way for users to trade tokens, and they play a crucial role in enabling decentralized exchange platforms to function smoothly and securely on the blockchain.

A way to deconstruct the swap transaction is to understand it via the transfer transactions. In this view, two steps occur: First, token A is sent by the swapping wallet to the LP smart contract, and second, an equivalent amount of token B minus the fees and tax are sent back to the swapping wallet.

The current state of the art depends on detecting the LP to determine if the transaction is done as a transfer or part of a swap. This limitation fixes the token to operate correctly only on the selected LP.

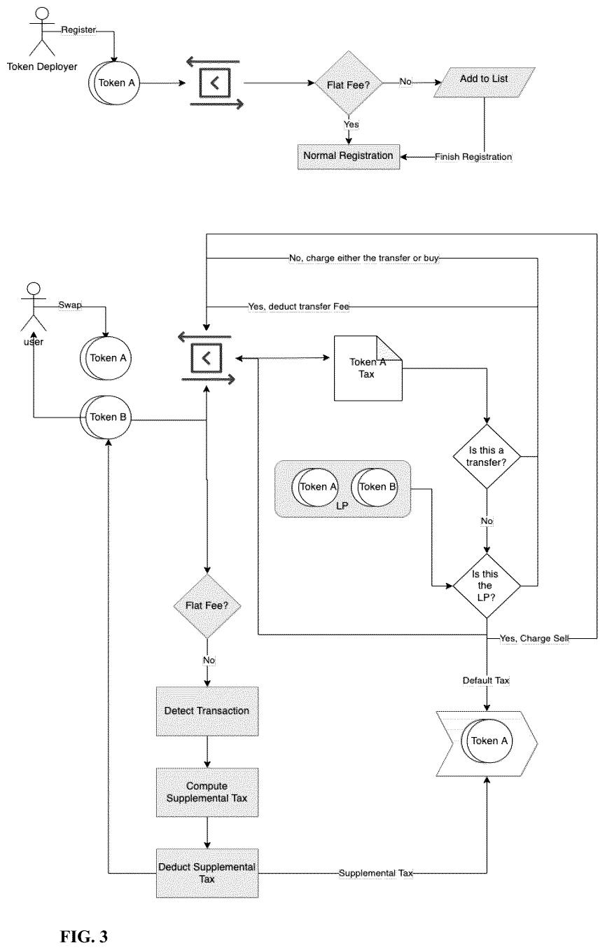

FIG. 3, depicts one way of implementing the embodiment, in which, a token is registered with the STP, providing the required supplemental tax in one or all of the transaction cases such as: transfer, buy, or sell. When a transaction is initiated on the DEX, the system would check if the token is registered in the STP. If the token is registered, a supplemental tax is charged to the user to correct the actual tax deducted.

In another exemplary embodiment, the token is registered in the STP with a reference to the hardcoded DEX. The hardcoded DEX is the one that correctly deducts the tax. The system would automatically calculate the supplemental tax based on the reference DEX. When a transaction is initiated on the DEX, the system would check if the token is registered in the STP. If the token is registered, a supplemental tax is charged to the user to correct the actual tax deducted.

As shown in FIG. 3, the user inputs an order for a token transaction through a DEX application on his user device, which order is communicated to the DEX server, resulting in the following steps:
1. the DEX smart contract determines valuation of the tokens to be sold, purchased or transferred;
2. if DEX smart contract determines the default tax amount to be levied against those tokens to be sold or transferred by the user;
3. if the transaction is a transfer, the DEX smart contract reviews the LP smart contract to determine if the tokens requested for transfer are in the LP;
4. if the transaction is a transfer and the LP contains the tokens to be transferred, the DEX smart contract determines the correct transfer fee to be charged;
5. if the transaction is a sale or purchase, the DEX smart contract communicates the correct tax amount to the user device and the DEX dApp on the user device prompts the user to execute or cancel the order;
6. if the transaction is a transfer, the DEX smart contract determines whether the tax is flat, symmetric or asymmetric;
7. if the DEX smart contract determines an asymmetric tax is applicable to a transfer transaction, the DEX smart contract registers the token with the STP and verifies that the token appears on the STP register;
8. once the STP is engaged, it computes the supplemental tax applicable to the transaction and the DEX server communicates the total tax amount, including the default and supplemental tax, to the user device and the DEX dApp on the user device prompts the user to execute or cancel the order;
9. if the user executes the order through the user device application, the DEX smart contract executes the transaction, automatically deducts all applicable default and supplemental taxes and transfers tokens as computed into and/or out of the LP and the user's crypto wallet; and
10. upon execution of the transaction, the DEX smart contract transfers the tax withholding to the designated entity's wallet.

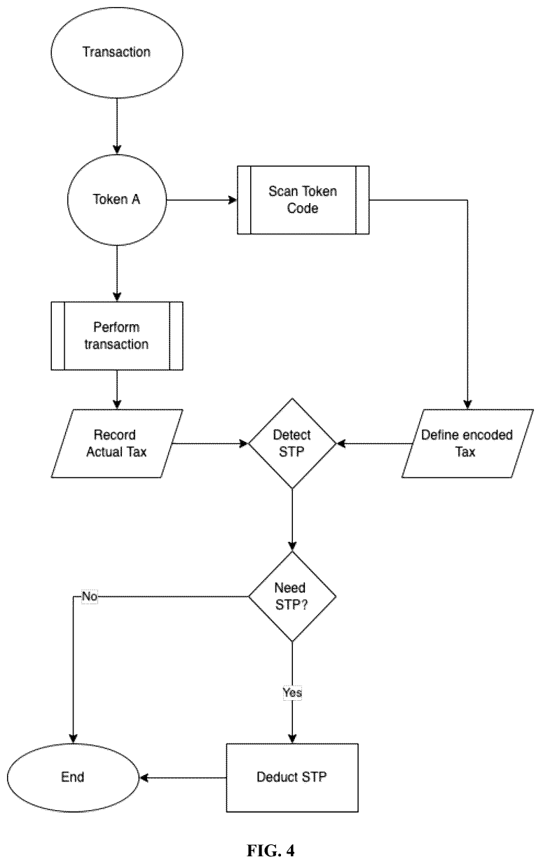

As depicted in FIG. 4, a different implementation of the embodiment utilizes automatic detection of the tax code. The STP would automatically detect the encoded tax by methods such as: parsing the token contract code. The Supplemental Tax Protocol (STP) presents a distinct implementation of a system that aims to automatically detect and apply the appropriate tax code to transactions involving tokens or assets on a blockchain. In this context, the tax code refers to any applicable tax rates, regulations, or requirements that need to be considered when executing transactions.

The innovative aspect of the STP lies in its ability to perform automatic tax code detection without relying on external interventions. Instead, the protocol employs sophisticated methods, one of which involves parsing the token contract code. When a transaction occurs on the blockchain involving a particular token, the STP would access and analyze the smart contract code associated with that token. Through advanced parsing techniques, it can identify and extract relevant information regarding tax-related rules encoded within the contract.

By leveraging this automatic detection process, the STP streamlines the implementation of tax protocols, enhancing efficiency and reducing the possibility of manual errors. Traditional tax compliance often demands time-consuming and manual verification processes, but the STP's automation can significantly reduce this burden.

Furthermore, the STP can cater to dynamic tax regulations and changes without necessitating modifications to its core functionalities. As long as the token contract's code adequately incorporates any updates to the tax code, the STP will adapt accordingly.

However, it is essential to ensure the security and accuracy of the STP's detection mechanisms. Rigorous testing and auditing processes are necessary to identify and rectify any potential vulnerabilities. Moreover, developers must ensure that the protocol remains compatible with different blockchain networks and token standards to achieve broader adoption.

Overall, the STP's automatic detection of the tax code represents a promising advancement in the domain of blockchain-based financial applications, providing a more efficient, reliable, and adaptable approach to taxation in the digital age. The STP would compare the actual tax deducted in the transaction against the one detected from the methods above. When a transaction is initiated on the DEX, the system will automatically determine if the token qualifies for the STP without registration. If the token qualifies, a supplemental tax is charged to the user to correct the actual tax deducted.

In the iteration of FIG. 4, step 7 is revised as follows:
7. the DEX processor engages the STP, automatically parses the token contract code which determines whether a supplemental tax is associated with the token and, if so, calculates the supplemental tax amount.

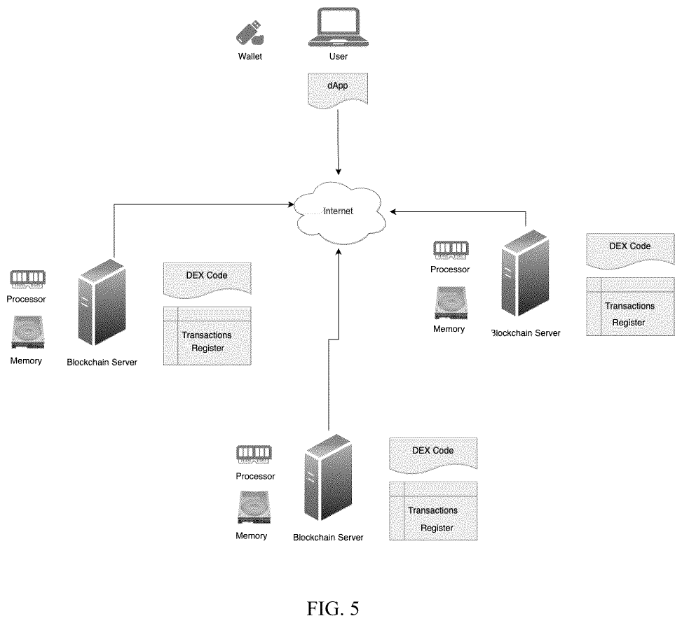

FIG. 5 is a chart showing the interrelation of hardware components containing the software comprising the inventive STP system. A user device with a processor and memory containing a dApp with a user's crypto wallet for interfacing with a DEX is connected to a plurality of servers, each server comprising a server processor and server memory containing the DEX code/protocol and a register of all transactions. The DEX code comprises a liquidity pool one or more DEX smart contracts (not pictured separately) for the execution of cryptocurrency transactions. The STP and STP transaction register are comprised in the DEX code/protocol and/or the associated register. Collectively, the servers and contents thereof comprise a blockchain. All components are connected by and able to communicate via an internet, intranet, or similar communication system, thus allowing the user to initiate and execute crypto transactions on the blockchain from the dApp on the user device.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A system for calculating and deducting supplemental taxes in cryptocurrency transactions, such system comprising the following components:
a. one or more user devices, each such user device comprising a processor, an input feature, a memory containing a decentralized exchange application (dApp), such dApp comprising a crypto wallet;
b. a plurality of servers comprising a blockchain, each such server with a processor and a memory containing a decentralized exchange protocol (collectively, a DEX), such protocol comprising a liquidity pool (LP) containing tokens, one or more DEX smart contracts and one or more LP smart contracts;
c. a supplemental tax protocol (STP) with an STP register, each residing on each server memory and engaged by the DEX; and
d. an internet, intranet or similar means of communication between such system components;
wherein the system executes the following steps:
1. initiating a proposed cryptocurrency transaction, such transaction a transfer, buy or sell transaction, by the user on the user device;
2. determining a valuation of the tokens to be sold, purchased or transferred with the DEX smart contract;
3. determining a default tax amount to be levied against those tokens to be sold or transferred by the user with the DEX smart contract;
4. if the transaction is a transfer, reviewing the LP smart contract contents with the DEX smart contract to determine if the tokens requested for transfer are in the LP;
5. if the transaction is a transfer and the LP contains the tokens to be transferred, determining the correct transfer fee to be charged with the DEX smart contract;
6. if the transaction is a sale or purchase, communicating the correct default tax amount from the DEX smart contract to the dApp on the user device, wherein the dApp then prompts the user to execute or cancel the order;
7. if the transaction is a transfer, determining whether the tax is flat, symmetric or asymmetric with the DEX smart contract;
8. if an asymmetric tax is applicable to a transfer transaction, engaging the STP with the DEX smart contract;
9. registering the token with the STP and verifying that the token appears on the STP register;
10. once the STP is engaged, computing the supplemental tax applicable to the transaction with the DEX smart contract and communicating the combined default and supplemental tax amount to the dApp on the user device, prompting the user to execute or cancel the order;
11. if the user executes the order through the dApp, executing the transaction with the DEX smart contract, thereby automatically deducting all applicable default and supplemental taxes and transferring tokens as computed into and/or out of the LP and the user's crypto wallet; and
12. upon execution of the transaction, transferring the withheld tax from the DEX smart contract to the designated entity's wallet.

2. The system of claim 1, wherein step 10 reads as follows: automatically parsing a contract code of the token with the STP and determining whether a supplemental tax is associated with the token and, if so, calculating the supplemental tax amount.

3. A method of deducting a supplemental tax on a token transaction with the system of claim 1, comprising the steps:
1. registering a token with the STP;
2. calculating an actual tax to be deducted in relation to a transfer, buy or sell transaction;
3. calculating the required supplemental tax in the transaction
4. initiating the transaction on the DEX smart contract;
5. verifying that the token appears on the STP register; and
6. charging a supplemental tax in addition to the actual tax deducted upon execution of the transaction.
